(19) United States
(12) Patent Application Publication
(10) Pub. No.: US 2022/0327965 A1
(43) Pub. Date: Oct. 13, 2022

(54) Custom Image Decoder for Visual, Machine-Readable Representation of Data

(71) Applicant: ZEBRA TECHNOLOGIES CORPORATION, Lincolnshire, IL (US)

(72) Inventors: Debraj Dhar, Bangalore (IN); Sabir Valappil Thattath, Bangalore (IN)

(21) Appl. No.: 17/225,689

(22) Filed: Apr. 8, 2021

(51) Int. Cl. G09C 1/00; H04L 29/06; G06N 20/00

(52) U.S. Cl. CPC G09C 1/00; H04L 63/083; G06N 20/00

(57) ABSTRACT

Methods and systems for decoding custom, encrypted image data are disclosed herein. An example system includes a server including a set of data corresponding to one or more objects, and a device communicatively coupled with the server. The device may be configured to capture image data featuring a customized image associated with an object of the one or more objects, and decode an encrypted payload associated with the image data. The encrypted payload may be encoded in the image data pursuant to a non-standardized format. The device may also decrypt the encrypted payload, and transmit the decrypted payload to the server to obtain data corresponding to the object.

### BACKGROUND

Visual, machine-readable representations of data, including barcodes, quick response (QR) codes, radio-frequency identification (RFID) tags, and many others, have gained near universal acceptance in many prominent industries to quickly and easily facilitate numerous purposes (e.g., product purchasing, airplane ticket verification, sensitive document security, etc.). Conventional automatic identification and data capture (AIDC) devices configured to interpret these representations rely on a particular symbology that encodes a message into the representation of the data to interpret the message. These symbologies are typically defined by standards dictating how data may be encoded, such that a single data string will always encode into a particular visual, machine-readable representation.

Problematically, these standards limit the security associated with data encoded using particular symbologies. Encoding a first data string into a barcode format, for example, will always result in an identical barcode, such that there is only one proper decoded message resulting from decoding the barcode. Thus, any user with a scanning device (e.g., smartphone, handheld barcode scanner, etc.) can decode the first data string from the barcode. Moreover, these standards associated with conventional encoding symbologies prevent employees or others tasked with scanning the visual representations from easily verifying that the visual representation (e.g., barcode) corresponds to the object to which it is attached or otherwise associated. For example, grocery clerks may be unable to easily verify that a scanned barcode corresponds to the product to which it is affixed, resulting in the purchaser receiving an improper lower price for an item (an issue commonly referred to as “ticket switching”).

Accordingly, there is a need for a custom image decoder that can accurately and efficiently decode customized visual, machine-readable representations of data.

### SUMMARY

In one embodiment, the present invention is a system for decoding custom, encrypted image data. The system comprises a server including a set of data corresponding to one or more objects, and a device communicatively coupled with the server. The device is configured to: capture image data featuring a customized image associated with an object of the one or more objects; decode an encrypted payload associated with the image data, wherein the encrypted payload is encoded in the image data pursuant to a non-standardized format; decrypt the encrypted payload; and transmit the decrypted payload to the server to obtain data corresponding to the object.

In a variation of this embodiment, the customized image is representative of a human-recognizable object. Further in this variation, the human-recognizable object substantially correlates to the object, thereby enabling a user to authenticate the data corresponding to the object.

In another variation of this embodiment, the non-standardized format corresponds to a non-standardized matching between the encrypted payload and the customized image.

In yet another variation of this embodiment, the device is further configured to: receive, from a user, a passcode; and responsive to receiving the passcode, decode the encrypted payload associated with the image data.

In still another variation of this embodiment, the image data is a set of binary data, and the device is further configured to: apply a binary-to-text encoding algorithm to the image data to decode the encrypted payload. Further in this variation, the binary-to-text encoding algorithm is a Base64 encoding algorithm.

In yet another variation of this embodiment, the data corresponding to the object is an action comprising at least one of (i) following a link to a video corresponding to the object, (ii) retrieving a document associated with the object, and (iii) activating a function of the device. Moreover, the device is further configured to: receive, from the server, the data corresponding to the object; and perform the action.

In still another variation of this embodiment, the device is further configured to: train, by a scan engine, a machine learning-based image processing algorithm to decode image data featuring a customized image associated with an object using (i) a set of training customized images and (ii) a set of training decrypted payloads; and apply the machine learning-based image processing algorithm to the image data to decode the encrypted payload associated with the image data.

In another embodiment, the present invention is a method for decoding custom, encrypted image data. The method comprises: capturing, by a device, image data featuring a customized image associated with an object; decoding, by the device, an encrypted payload associated with the image data, wherein the encrypted payload is encoded in the image data pursuant to a non-standardized format; decrypting, by the device, the encrypted payload; and transmitting, by the device, the decrypted payload to a server to obtain data corresponding to the object, wherein the server includes a set of data corresponding to one or more objects.

In a variation of this embodiment, the customized image is representative of a human-recognizable object. Further in this variation, the human-recognizable object substantially correlates to the object, thereby enabling a user to authenticate the data corresponding to the object.

In another variation of this embodiment, the non-standardized format corresponds to a non-standardized matching between the encrypted payload and the customized image.

In yet another variation of this embodiment, the method further comprises: receiving, from a user interacting with the device, a passcode; and responsive to receiving the passcode, decoding, by the device, the encrypted payload associated with the image data.

In still another variation of this embodiment, the image data is a set of binary data, and the method further comprises: applying, by the device, a binary-to-text encoding algorithm to the image data to decode the encrypted payload. Further in this variation, the binary-to-text encoding algorithm is a Base64 encoding algorithm.

In yet another variation of this embodiment, the data corresponding to the object is an action comprising at least one of (i) following a link to a video corresponding to the object, (ii) retrieving a document associated with the object, and (iii) activating a function of the device. Moreover, the method further comprises: receiving, at the device, the data corresponding to the object; and performing, by the device, the action.

In still another variation of this embodiment, the method further comprises: training, by a scan engine included in the device, a machine learning-based image processing algorithm to decode image data featuring a customized image associated with an object using (i) a set of training customized images and (ii) a set of training decrypted payloads; and applying, by the scan engine, the machine learning-based image processing algorithm to the image data to decode the encrypted payload associated with the image data.

In yet another embodiment, the present invention is a tangible machine-readable medium comprising instructions that, when executed, cause a machine to at least: capture image data featuring a customized image associated with an object; decode an encrypted payload associated with the image data, wherein the encrypted payload is encoded in the image data pursuant to a non-standardized format; decrypt the encrypted payload; and transmit the decrypted payload to a server to obtain data corresponding to the object, wherein the server includes a set of data corresponding to one or more objects.

In a variation of this embodiment, the customized image is representative of a human-recognizable object that substantially correlates to the object, thereby enabling a user to authenticate the data corresponding to the object. Further in this variation, the non-standardized format corresponds to a non-standardized matching between the encrypted payload and the customized image.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a perspective view of a scanning device capturing an image of a customized image featured on a portion of an object, in accordance with various embodiments of the present invention.

FIG. 2 is a block diagram representative of an example logic circuit capable of decoding encrypted, customized image data, in accordance with embodiments described herein.

FIG. 3 illustrates an example system configured to decode encrypted, customized image data, in accordance with various embodiments of the present invention.

FIG. 4A illustrates an example venue in the form of a grocery store in which the example systems of FIG. 3 may decode encrypted, customized image data associated with objects within the example venue, in accordance with various embodiments of the present invention.

FIG. 4B illustrates another example venue in the form of an airport in which the example systems of FIG. 3 may decode encrypted, customized image data associated with objects within the example venue, in accordance with various embodiments of the present invention.

FIG. 5 illustrates an example method for decoding encrypted, customized image data, in accordance with various embodiments of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Generally speaking, entities that utilize encoding symbologies design their AIDC systems (also referenced herein as “encoding/decoding systems”) in a manner to maximize data security. Grocery chains, for example, generally store product prices on servers accessible only to authorized devices to provide some measure of security. These systems are generally useful, but suffer from a number of drawbacks. For example, conventional AIDC systems are unable to prevent external (e.g., unauthorized) users from decoding the payload encoded into a particular visual representation (also referenced herein as a “visual, machine-readable representation of data,” and/or a “representation of data,” and/or a “representation”). Continuing the grocery store example, should the external user successfully scan a barcode (e.g., decode the barcode payload) and gain access to the server where prices are stored, then the only security measure of the AIDC system is rendered useless. Moreover, conventional AIDC systems prevent users from easily and independently verifying whether or not the visual representation attached/affixed/associated with a product (also referenced herein as an “object”) is accurate, resulting in problematic situations such as ticket switching.

The methods/systems of the present disclosure provide solutions to the security problems associated with traditional AIDC systems. Namely, the methods/systems of the present disclosure alleviate problems associated with unsecured payload data and unverifiable visual representations associated with products. For example, a method of the present disclosure includes capturing, by a device, image data featuring a customized image associated with an object; decoding, by the device, an encrypted payload associated with the image data, wherein the encrypted payload is encoded in the image data pursuant to a non-standardized format; decrypting, by the device, the encrypted payload; and transmitting, by the device, the decrypted payload to a server to obtain data corresponding to the object, wherein the server includes a set of data corresponding to one or more objects. In this manner, the disclosure of the present application greatly increases the security of sensitive payload data that conventional AIDC systems overlook, and allows users to quickly and easily verify the association of a visual representation with an associated product as conventional AIDC systems are unable to do. As a result, the methods/systems of the present disclosure maximize visual representation flexibility and increase overall transaction security and consumer satisfaction.

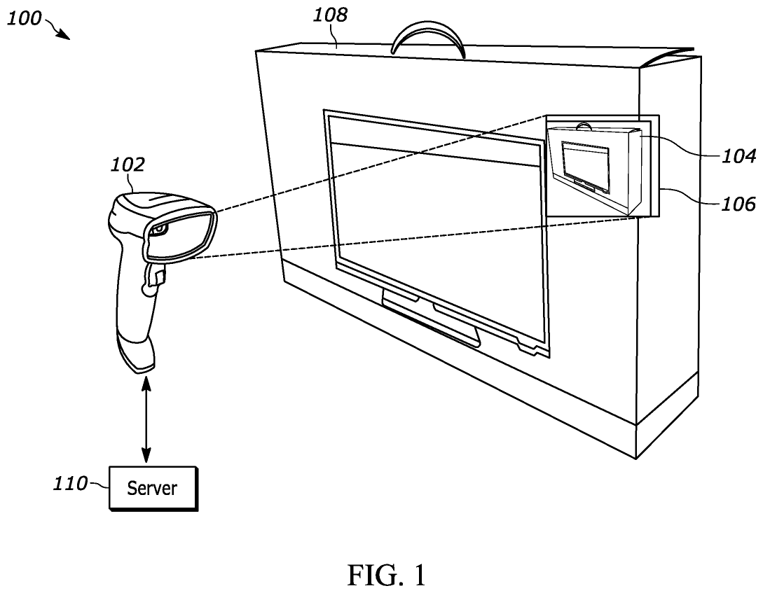

Referring now to the drawings, FIG. 1 is a perspective view of a scanning device 102 capturing an image of a customized image 104 (also referenced herein as an “indicia”) featured on a portion 106 of an object 108, in accordance with various embodiments of the present invention. Generally, the customized image 104 may include image data that is encoded with an encrypted, customized payload that may include, for example, an identification code corresponding to a particular object (e.g., object 108). The scanning device 102 may capture an image of the customized image 104 and analyze the image data corresponding to the customized image 104 to decode the payload from within the image data. The payload included as part of the image data may be encrypted, such that the scanning device 102 may decrypt the payload once decoded. This decrypted payload may correspond to a data entry (e.g., corresponding to object 108) included as part of a server 110, and the scanning device 102 may transmit the decrypted payload to the server 110 to retrieve the data entry. When the server 110 verifies that the received decrypted payload corresponds to a stored data entry, the server 110 may transmit the associated data entry to scanning device 102 for presentation to a user.

In particular, the customized image 104 may be any suitable image that a user chooses to associate with the object 108, and the payload encoded in the customized image 104 may be encoded and encrypted in any format/sequence that the user desires. Encoding such a customized, encrypted payload into a customized image 104 may be considered a “non-standardized” matching because the association of the customized, encrypted payload with the customized image 104 is not dependent upon the particular physical configuration of the customized image 104 (unlike, for example, traditional barcodes). For example, as illustrated in FIG. 1, the object 108 is a box containing a television, and the customized image 104 is an image of the box containing the television. In this example, the user may configure the scanning device 102 (and only other connected/authorized devices) to analyze the image data associated with the customized image 104 of the box containing the television and decode a customized, encrypted payload from the analysis. The user may further configure the scanning device 102 to decrypt the customized, encrypted payload according to a customized encryption methodology that may also only be accessible to the scanning device 102 and other connected/authorized devices. As a result, the scanning device 102 may transmit a customized, decrypted payload to the server 110, where the server 110 includes data entries corresponding to each customized, decrypted payload specified by the user during AIDC system (used herein to reference the scanning device 102 and server 110 combination) configuration. Each data entry may correspond to one or more objects, and may represent any suitable data/information corresponding to the one or more objects. In this example, the data entry of interest may correspond to the price of the television contained in the box in the customized image 104.

Continuing the above example, the server 110 may receive the customized, decrypted payload from the scanning device 102 and may compare the customized, decrypted payload associated with the box containing the television to some/all identifiers associated with data entries included in the server 110 to identify a match. If the server 110 identifies a match between the customized, decrypted payload and an identifier associated with a data entry in the server 110, then the server 110 may transmit the data entry to the scanning device 102 for presentation to a user. As a result, the scanning device 102 may receive the data entry from the server 110 and display the data entry (e.g., price information corresponding to the television contained in the box in the customized image 104) for viewing by a user. Thus, in this example, the AIDC system securely retrieves price data corresponding to the television contained in the box in the customized image 104 in a manner previously unachievable by conventional AIDC systems because the indicia and corresponding payload are coupled in a non-standardized matching which is only decodable by connected/authorized devices, the payload is encrypted in a user-configurable manner that may only be decrypted by connected/authorized devices, and the customized image 104 may correspond directly to and/or bear a substantial similarity to the object 108, allowing users to quickly and easily visually verify that the retrieved data entry corresponds to the object 108.

As another example, assume that a customer is attempting to obtain a cheaper price for the television represented by the object 108 by ticket switching, such that the customized image attached to the object 108 is instead a box of cereal. Further, assume that the user operating the scanning device 102 recognizes that the customized image attached to the object 108 does not represent the object 108 (e.g., the customized image is a box of cereal instead of a television or a box containing a television). The now suspicious user may capture an image of the customized image, and may receive a data entry stating that the object corresponding to the customized image costs five dollars. Because the user was previously alerted to the curious association of a customized image of a cereal box with a television set, the user will likely pay close attention to the retrieved data entry to notice that the object 108 clearly does not cost five dollars, as suggested by the data entry corresponding to the cereal box customized image. As a result, the user may take appropriate action to prevent an improper sale of a television set for five dollars due to intentional ticket switching (or in other cases, inadvertent erroneous indicia misplacement). By contrast, conventional indicia (e.g., barcodes, QR codes, etc.) provide no such visual cues that might signal a user that the indicia attached to the object 108 does not correspond to the object 108. Thus, the user may not catch or otherwise be alerted to a situation where the data entry retrieved corresponding to the attached indicia does not correspond to the object 108. These issues associated with conventional indicia and AIDC systems generally may be particularly pronounced in situations such as busy, fast-moving checkout lines where the indicia of multiple items/objects are scanned/imaged in a brief period, leaving little time to verify each individual association of indicia to the corresponding item/object.

To establish these non-standardized matchings of the customized, encrypted payloads with the customized images (e.g., customized image 104), the user may generate a database containing each payload/image pairing. Generally, the user may select any image that the user desires to associate with a particular object (e.g., object 108) and the user may also select the payload the user desires to be encoded within the image. The user may also generate object data that corresponds to the payload, and may store the object data separately from the payload/image pairing. For example, the user may generate a database that includes a payload/image pairing corresponding to the customized image 104. The payload/image pairing may include a data string (e.g., “123ABC”) as at least a part of the payload that is encoded within the customized image 104, such that when the scanning device 102 captures an image of the customized image 104, the scanning device 102 may associate, retrieve, and/or otherwise obtain the data string. The scanning device 102 may then transmit the data string to another database (e.g., server 110) that contains the object data, wherein the server 110 may match the data string to an identifier associated with the object data and the server 110 may also transmit the object data to the scanning device 102 for presentation to a user.

Further, the user may apply an encryption technique to the payloads, such that even if the payload is successfully decoded from the image data, the payload may only be decrypted if the scanning device is registered as part of the AIDC system. For example, the user may require password entry, prior staging at a particular location or by receiving a particular user's (e.g., an AIDC system administrator's) credentials, and/or any other suitable security measure or combinations thereof in order for a scanning device that captures an image of a customized image to decode and/or decrypt the corresponding payload. Of course, it is to be understood that the user may store the non-standardized matchings, the encryptions, and/or the object data in a database that is separate from the scanning device (e.g., server 110) and/or on the scanning device. Moreover, it should be appreciated that the scanning device 102 may be communicatively coupled with the server 110 to transmit/receive decoded/decrypted payloads and object data. In some embodiments, for example, the scanning device 102 and the server 110 may be directly communicatively coupled by a wireless communication protocol (e.g., Bluetooth, WiFi, Bluetooth Low Energy (BLE), ZigBee, Z-Wave, Near Field Communication (NFC), Radio-Frequency Identification (RFID), 3G, 4G, 5G, etc.).

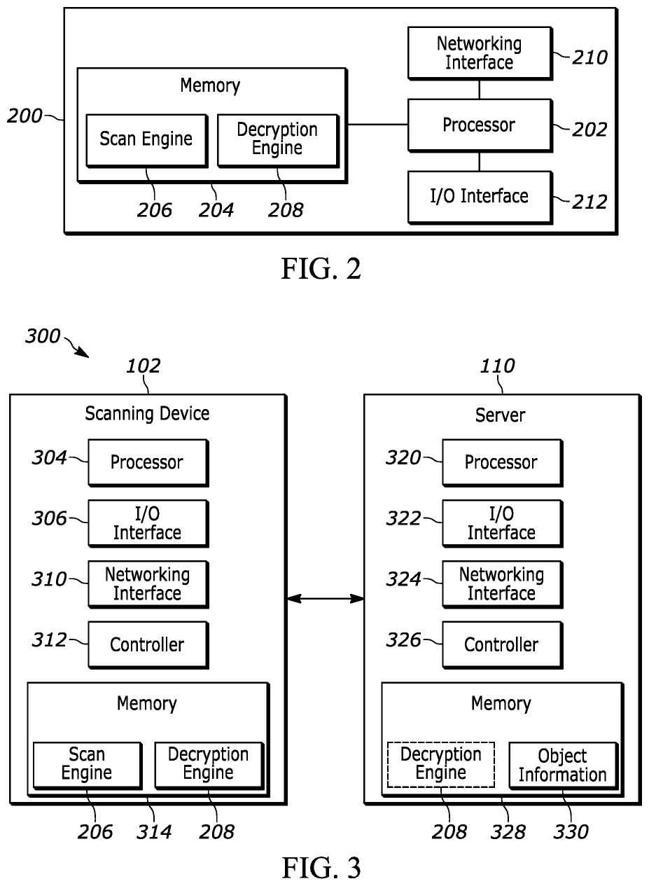

FIG. 2 is a block diagram representative of an example logic circuit capable of implementing, for example, one or more components of the scanning device 102 of FIG. 1. The example logic circuit of FIG. 2 is a processing platform 200 capable of executing instructions to, for example, implement operations of the example methods described herein, as may be represented by the flowcharts of the drawings that accompany this description. Other example logic circuits capable of, for example, implementing operations of the example methods described herein include field programmable gate arrays (FPGAs) and application specific integrated circuits (ASICs).

The example processing platform 200 of FIG. 2 includes a processor 202 such as, for example, one or more microprocessors, controllers, and/or any suitable type of processor. The example processing platform 200 of FIG. 2 includes memory (e.g., volatile memory, non-volatile memory) 204 accessible by the processor 202 (e.g., via a memory controller). The example processor 202 interacts with the memory 204 to obtain, for example, machine-readable instructions stored in the memory 204 corresponding to, for example, the operations represented by the flowcharts of this disclosure. The memory 204 also includes a scan engine 206 and decryption engine 208 that are accessible by the example processor 202. The scan engine 206 may include rule-based instructions, an artificial intelligence (AI) and/or machine learning-based model, and/or any other suitable algorithm architecture or combination thereof configured to analyze and interpret captured image data of a customized image and to decode an encoded payload from the customized image. For example, the example processor 202 may access the memory 204 to execute the scan engine 206 when a scanning device (e.g., scanning device 102) captures an image of a customized image affixed/associated with an object. The decryption engine 208 may include rule-based instructions configured to decrypt payloads that are received from the scan engine 206. For example, the scan engine 206 may decode an encrypted payload from an image of a customized image that is captured by a scanning device, and the scan engine may transmit the encrypted payload to the decryption engine to decrypt the encrypted payload. In this example, the decryption engine 208 may decrypt the encrypted payload in accordance with one or more encryption techniques applied to the encrypted payload. Additionally or alternatively, machine-readable instructions corresponding to the example operations described herein may be stored on one or more removable media (e.g., a compact disc, a digital versatile disc, removable flash memory, etc.) that may be coupled to the processing platform 200 to provide access to the machine-readable instructions stored thereon.

The example processing platform 200 of FIG. 2 also includes a network interface 208 to enable communication with other machines via, for example, one or more networks. The example network interface 208 includes any suitable type of communication interface(s) (e.g., wired and/or wireless interfaces) configured to operate in accordance with any suitable protocol(s) (e.g., Ethernet for wired communications and/or IEEE 802.11 for wireless communications).

The example, processing platform 200 of FIG. 2 also includes input/output (I/O) interfaces 210 to enable receipt of user input and communication of output data to the user. Such user input and communication may include, for example, any number of keyboards, mice, USB drives, optical drives, screens, touchscreens, etc.

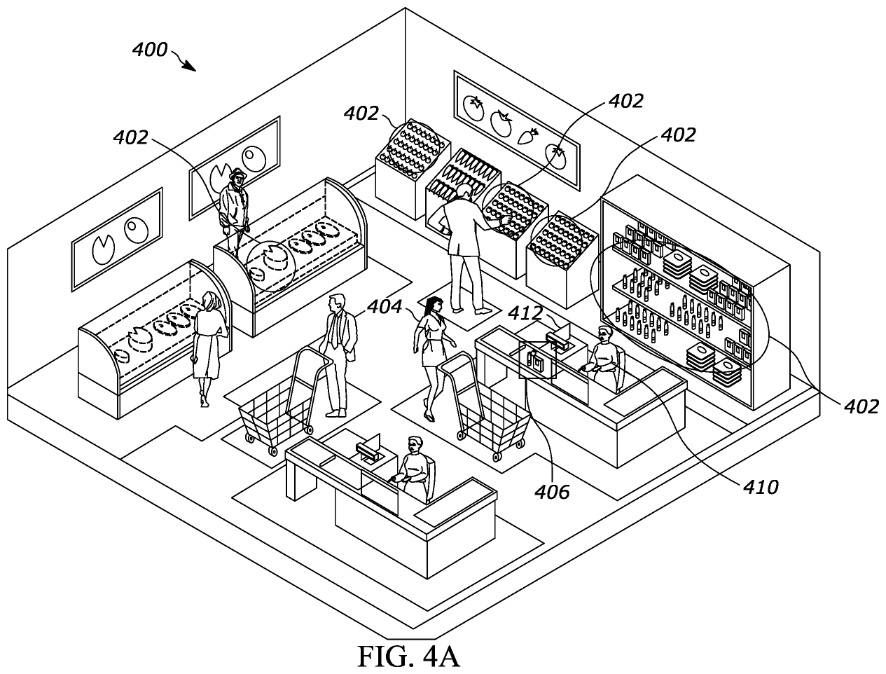

As illustrated in FIG. 3, an example system 300 that is configured to decode encrypted, customized image data includes the scanning device 102 and the server 110. The scanning device 102 includes a processor 304, an input/output (I/O) interface 306, a networking interface 310, a controller 312, and a memory 314. The memory 314 includes the scan engine 206 and the decryption engine 208. The server 110 includes a processor 320, an I/O interface 322, a networking interface 324, a controller 326, and a memory 328 that includes the object information 330. While referred to herein as a single “memory,” a single “controller,” and/or a single “processor,” in some embodiments the memory (314, 328), controller (312, 326), and/or processor (304, 320), includes two or more memories, two or more controllers, and/or two or more processors.

In this example system 300, the scanning device 102 and the server 110 may be configured to communicate via the networking interfaces (310, 324) using any suitable communication protocol. As an example, the scanning device 102 may utilize a Bluetooth communication protocol to communicate with the server 110. The scanning device 102 may generally transmit decoded and decrypted payloads to the server 110 in order to retrieve object data stored as part of the object information 330 in the memory 328 of the server 110. The server 110 may receive these decoded and decrypted payloads from the scanning device 102, compare the payloads to identifiers included as part of the object information 330 to identify a particular object data entry, and may transmit the identified object data entry and/or other signals back to the scanning device 102 in response. In certain embodiments, the scanning device 102 may include the object information 330 in the memory 314.

Additionally, the server 110 may initiate signal transmission to the scanning device 102 in response to a user input at the server 110. Further, in certain aspects, the server 110 may optionally include the decryption engine 208, and may receive decoded, encrypted payloads from the scanning device 102. In these aspects, the scanning device 102 may transmit the decoded, encrypted payload with a password/passcode, and the server 110 may only decrypt and continue to process the received payload if the password/passcode matches the password/passcode of record stored in memory 328. Additionally or alternatively, the scanning device 102 may only decode and decrypt the payload upon receipt of the password/passcode. In some instances, the password/passcode may be received from a user inputting the password/passcode on a user interface of the scanning device 102, the password/passcode may be received during the initial setup (e.g., staging) of the scanning device 102 as part of the AIDC system, and/or the server 110 may transmit the password/passcode to the scanning device 102 to enable the decoding and/or decryption of the payload.

Generally, and as previously mentioned, the scanning device 102 may capture an image of a customized image associated with an object, and may transmit a decoded, decrypted payload to the server 110. For example, the processor 304 may decode and decrypt a product identification code as some or all of the payload data. The scanning device 102 may analyze the captured image by causing the processors 304 to execute/apply the scan engine 206 stored in memory 314, and as a result, the processors 304 may decode an encrypted payload from the image data included as part of the captured image. For example, the scan engine 206 may include an image processing algorithm configured to decode/extract payload data from the captured image. The image processing algorithm may be a rules-based algorithm and/or may be an artificial intelligence-based (AI) algorithm that includes machine learning aspects configured to adaptively and intelligently analyze the captured image(s) in order to decode/extract payload data. Further, the scanning device 102 may recognize that the decoded payload is encrypted, and as a result, may cause the processors 304 to execute/apply the decryption engine 208 stored in memory 314 to decrypt the encrypted payload. For example, the decryption engine 208 may include a decryption algorithm configured to decrypt payload data from the captured image. The decryption algorithm may be a rules-based algorithm and/or may be an artificial intelligence-based (AI) algorithm that includes machine learning aspects configured to adaptively and intelligently analyze the decoded payload(s) in order to decrypt the payload data. It will be appreciated, that the user may utilize any suitable encryption technique(s), including classical cryptographic techniques (e.g., symmetric key, hash functions, asymmetric key, etc.), quantum cryptographic techniques (e.g., quantum key distribution, quantum coin flipping, position-based quantum cryptography, etc.), and/or any other suitable techniques or combinations thereof.

In any event, if the processor 304 successfully decodes and decrypts the payload data, the processor 304 may cause the controller 312 to transmit the payload data to the server 110 via the networking interface 310. Additionally or alternatively, the processor 304 may cause the controller 312 to store the decoded and decrypted payload data in the memory 314 along with a time stamp and the captured image data indicating when the image of the customized image was captured and the corresponding payload data was transmitted to the server 110.

Once received at the server 110, the processor 320 may query the object information 330 to identify a match between the received payload data and the stored object data entries. Generally, the object information 330 may include data entry identifiers in order to match received payload data with a particular object data entry. These data entry identifiers may include, for example, product identification numbers (e.g., a universal product code (UPC) number, user-specified number) that directly correspond to the object with which the customized image is associated. Thus, the processor 320 may evaluate all or some entries stored as part of the object information 330 to identify a match between one or more data entry identifiers and a portion of the received payload data. For example, assume that the payload data includes routing information and a product identification number, such that the routing information instructs the processor 304 to cause the controller 312 to transmit the payload data to the server 110 via the networking interface 310 and that the product identification number matches a data entry identifier stored in the object information 330. In this example, the processor 320 receives the payload data in accordance with the routing instructions, and the processor 320 also compares the product identification number to some or all of the data entry identifiers in the object information 330. The processor 320 may identify a match between the payload data and a data entry identifier, and may also transmit the stored object data corresponding to the matched data entry identifier to the scanning device 102.

In some aspects, the processor 320 may identify one or more matches between the data entry identifiers and the payload data, such that the processor 320 may return one or more data entries to the scanning device 102. For example, the object information 330 may include two separate entries for a first object, where a first entry corresponds to the price of the first object, and the second entry corresponds to a sale discount of the first object. In this example, the processor 320 may transmit both data entries to the scanning device 102, so that the user may receive an indication of the price and the sale discount associated with the first object. Moreover, the scanning device 102 and/or the server 110 may communicate with a user workstation to notify a user directly of, for example, a captured image and the corresponding retrieved object data. In this manner, the systems of the present disclosure may maximize processing resource efficiency and may more effectively communicate object data to relevant users than conventional systems.

In some aspects, the scanning device 102 or the server 110 may continuously and/or periodically communicate with the scanning device 102 or the server 110 to transmit/receive payload data, object data, and or any other suitable data. For example, the scanning device 102 may periodically receive credential check requests from the server 110 configured to determine whether or not the scanning device 102 is authorized to participate in the AIDC system (e.g., decode/decrypt customized image data, obtain object data). Upon receipt of such a request, a user of the scanning device 102 may be prompted to enter authorizing credentials, such as a password, passcode, and/or any other suitable credential(s) of combinations thereof. If the server 110 receives an authorizing credential from the scanning device 102, then the server 110 may permit the scanning device 102 to transmit decoded/decrypted payload data to the server 110. Further, the scanning device 102 may also independently request authorizing credentials in order to allow a user to decode and/or decrypt customized image data.

Additionally or alternatively, in certain aspects, the scanning device 102 and/or the server 110 may communicate directly with an external server and/or an external data source to accomplish some/all of the actions described herein. The external server may be a central storage server, a cloud network, and/or any other suitable type of external server, and the external data source may be the Internet and/or any other suitable external data source. For example, the scanning device 102 may capture an image of a customized image that includes a payload featuring a hyperlink associated with a video that includes demonstrations and/or general information concerning an object with which the customized image is associated. The scanning device 102 may decode and decrypt the image data, and may access the Internet (e.g., via the networking interface 310) to download or otherwise access the video by following the hyperlink. As another example, assume that the scanning device 102 is a user's mobile phone (e.g., a smartphone utilizing a camera or scanning application) and that the payload decoded from a customized image includes instructions to access an application of the mobile phone. The scanning device 102 may capture an image of the customized image, decode and decrypt the payload included in the image of the customized image, and may automatically access the application stored on the mobile phone in response to analyzing/interpreting the decoded and decrypted payload.

Moreover, each of the scanning device 102 and the server 110 may be in wired, wireless, direct, or networked communication with the external server, for example, through a network switch. Thus, each of the scanning device 102 and the server 110 may communicate through any suitable short-range communication protocol (e.g., WiFi, BLE, etc.), and/or may communicate with each other and/or the external server through any suitable long-range communication protocol (e.g., via the Internet, etc.).

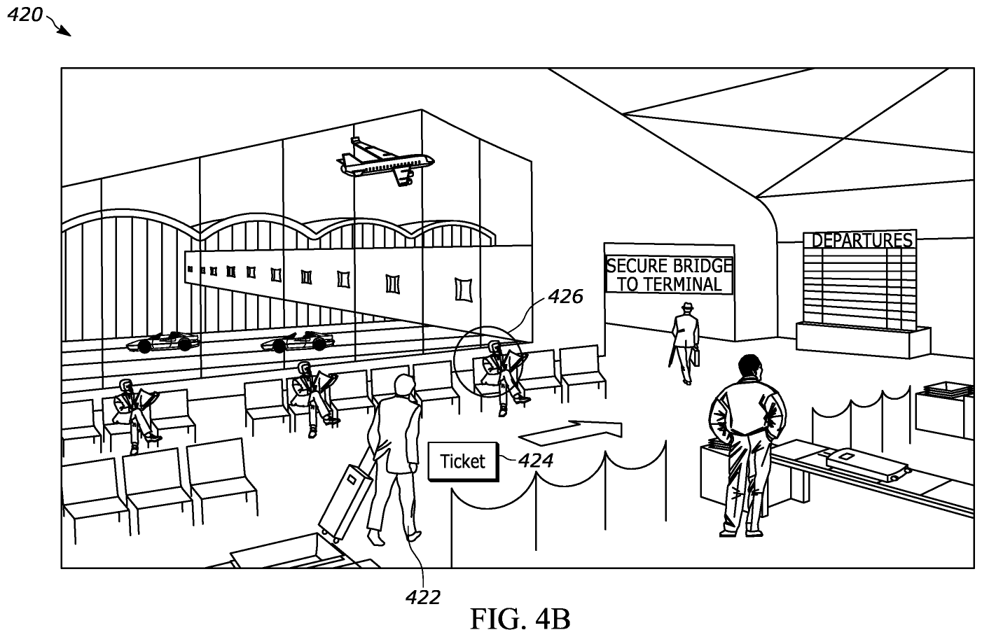

To illustrate the example system 300, FIG. 4A depicts an example venue 400 in the form of a grocery store in which movable objects 402 (e.g., grocery items), may be scanned/imaged and purchased using the devices/systems described herein. Of course, the venue 400 may be any indoor or outdoor venue, and may have any layout or configuration. Moreover, although the example venue 400 is illustrated as a grocery store, the disclosed embodiments may be implemented at other types of venues (such as a warehouse, an airport, a courthouse, a stadium, a performance center, a school, a hospital, etc.).

Generally speaking, FIGS. 4A and 4B illustrate how associating custom images that have custom, encrypted payloads with objects is important for any industry. In reference to FIG. 4A, during the course of a typical day inside a grocery store (e.g., venue 400), many movable objects 402 may be added, removed (e.g., purchased), and/or otherwise relocated within or outside of the grocery store. These moveable objects 402 may be entered into the AIDC system of the grocery store upon delivery, and may be scanned (e.g., imaged by a scanning device 102) upon purchase by a customer. If even a small percentage of these movable objects 402 are erroneously scanned at purchase, for example, due to ticket switching, then the grocery store may inaccurately track inventory due to falsely categorized purchases by customers. As a result, the grocery store may lose considerable profits from both the misquoted purchase price of each individual sale and erroneous inventory management (e.g., purchases of inventory for the grocery store), and may reduce overall customer satisfaction from an inadequate supply of high-demand products.

For example, assume that all movable objects 402 that are purchasable within the venue 400 include a customized image (e.g., customized image 104) that is encoded with an encrypted payload, as described herein. A customer 404 may gather multiple objects as the customer 404 traverses the venue 400, and may attempt to checkout of the grocery store by placing all gathered objects 406 onto a checkout aisle conveyor belt 406. The gathered objects 406 may proceed down the conveyor belt 406 until the objects 406 reach a checkout clerk 410, who may scan the gathered objects 406 by capturing an image of the customized image associated with each respective gathered object 406.

In this example, assume that the customer 404 attempts to purchase a first object of the gathered objects 406 at a lower price by ticket switching a first customized image associated with the first object with a second customized image associated with a second object that has a lower purchase price than the first object. Further, assume that the first object is a large bag of cat food, the first customized image represents a cat, the second object is a ketchup container, and the second customized image represents a red tomato. The checkout clerk 410 may scan the first object using a scanning device (e.g., scanning device 102) and may notice that the second customized image (e.g., a red tomato) does not logically correspond to the first object (e.g., a large bag of cat food). The checkout clerk's 410 suspicions may deepen when the object data returned to scanning device and/or the checkout aisle display 412 does not appear to accurately represent the price of the first object. Namely, the object data may indicate that the object associated with the second customized image costs three dollars, but the checkout clerk 410 may recognize that the actual object being purchased (e.g., the first object) should cost more than this quoted value.

Accordingly, in the prior example, the checkout clerk 410 may take remedial action to prevent the erroneous sale of the first object at a price corresponding to the second object by recognizing that the second customized image placed on the first object does not accurately represented the first object. By contrast, conventional AIDC systems provide no such security because the indicia used to scan/image individual products are indistinguishable to the human eye, or at a minimum, provide no inherent indication of correspondence with the object to which the indicia are attached/printed/etc. Thus, in conventional AIDC systems, a checkout clerk may inadvertently permit ticket switching and/or other erroneous purchases because there is no obvious indication that the scanned/imaged indicia does not correspond to the object to which it is attached/printed/etc. However, the systems and methods of the present disclosure may also provide enhanced security associated with AIDC indicia by preventing payload decoding/decryption entirely.

In reference to FIG. 4B, the example venue 420 may be an airport in which hundreds, if not thousands, of persons may simultaneously await the departure/arrival of respective flights. Generally, airports issue tickets to passengers, and more recently, airline tickets may include traditional indicia (e.g., QR codes) that airport staff may scan to obtain the passenger's identification information and flight reservation. Problematically, these recent developments allow other persons present in the airport to scan a passenger's ticket using, for example, a smartphone QR code scanner and obtain private information. However, the systems and methods of the present disclosure alleviate such problems by disabling unauthorized scanning devices from obtaining payload data from a captured indicia image.

For example, assume that the passenger 422 checks in for a respective flight, and receives a ticket 424 including customized image (e.g., representing the passenger's 422 likeness, destination, etc.) that includes a payload featuring personal identification information, flight information, etc. Further, assume that the passenger 422 is heading from a security checkpoint to their respective gate to await their flight's departure when the passenger 422 inadvertently drops their ticket 424 while removing their passport/billfold/etc. from their pocket. Assume that the passenger 426 witnesses the passenger 422 drop the ticket 424 and fail to notice, as the passenger 422 proceeds toward the respective gate. The passenger 426 may approach the dropped ticket 424, pick it up, and attempt to scan the customized image with a personal mobile device in order to obtain the sensitive information contained therein. Unfortunately for the passenger 426, the personal mobile device may not be included as an authorized device within the airport AIDC system, and may therefore be unable to decode and/or decrypt any payload included as part of the image of the customized image. Thus, the systems and methods of the present disclosure provide increased security associated with AIDC indicia by preventing payload decoding/decryption entirely in the event that the scanning device is not authorized (e.g., staged as part of the AIDC system) to participate in the AIDC system which was previously unachievable with conventional AIDC systems.

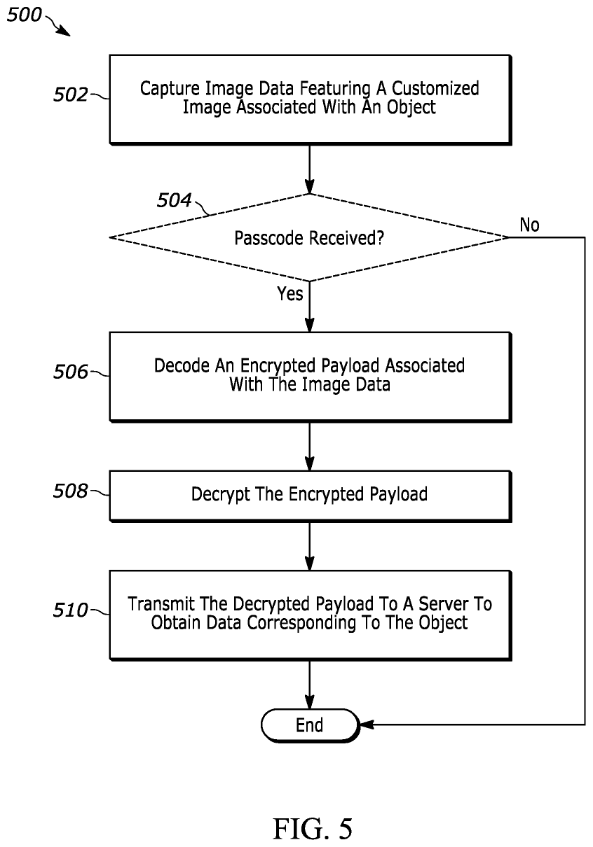

FIG. 5 illustrates an example method 500 decoding encrypted, customized image data, in accordance with various embodiments of the present invention. It should be understood that, in certain embodiments, any of the blocks of the method 500 may be performed by the scanning device 102, and some blocks of the method 500 may be performed by the server 110, an external server, and/or any other suitable device. Moreover, certain blocks of the method 500 may be optional (e.g., block 506).

The method 500 begins at block 502, where, for example, a scanning device (e.g., scanning device 102) captures image data featuring a customized image associated with an object. Generally, the customized image may be any image or representation a user chooses to associate payload data with an object. As such, the customized image may be any visual representation that includes a rendering of a human-recognizable object, a string of alphanumeric characters, colors, symbols, etc. For example, a user may choose to associate an image of a dog with a dog bed that is purchasable within a pet store by encoding payload data corresponding to the dog bed within the customized image of the dog. Alternatively, the user may choose to associate an image of a bed with the dog bed, or the user may choose to associate an orange square with the dog bed, or any other customized image by encoding payload data corresponding to the dog bed within the customized image of the bed or the customized image of the orange square.

In certain embodiments, the customized image is representative of a human-recognizable object. Moreover, in these embodiments, the human-recognizable object may substantially correlate to the object, thereby enabling a user to authenticate the data corresponding to the object. Continuing the above example, if the user chooses to encode payload data corresponding to the dog bed within the customized image of the dog, then the customized image represents a human-recognizable object (e.g., a dog) that substantially correlates to the object (e.g., a dog bed). Of course, the human-recognizable object may substantially correlate to the object by having some logical tether between the human-recognizable object represented in the customized image and the object, and may not need to identically represent the object.

The method 500 may optionally include, at block 504, a user inputting a passcode/password prior to the scanning device decoding the encrypted payload. The user may input the passcode/password after the scanning device captures the image data (block 502) and/or the user may input the passcode/password during the staging (e.g., the initial setup) of the AIDC system. Further, the user may input the passcode/password by interacting with a user interface of the scanning device, utilizing a workstation that is communicatively coupled with the scanning device, by accessing the server (e.g., server 110), and/or by any other suitable means. In these embodiments, and responsive to receiving the passcode, the scanning device may decode the encrypted payload associated with the image data.

The method 500 may also include, at block 506, decoding an encrypted payload associated with the image data. As previously mentioned, the encrypted payload may be encoded in the image data pursuant to a non-standardized format corresponding to a non-standardized matching between the encrypted payload and the customized image. Namely, the payload encoded within the customized image (e.g., as part of the image data) is not dependent upon the physical configuration of the customized image, and therefore constitutes a non-standardized matching between the encrypted payload and the customized image that was previously unachievable using conventional AIDC systems.

The scanning device may utilize the scan engine (e.g., scan engine 206) to apply an image processing algorithm to decode the encrypted payload. Generally, the image processing algorithm may be trained to decode the encrypted payload according to particular non-standardized matchings prior to the scanning device capturing the image data featuring the customized image (block 502). This training may include a user establishing a database of the non-standardized matchings, which the image processing algorithm may reference to decode the encrypted payload. Additionally or alternatively, the image processing algorithm may be an AI/ML-based model, and the training may include training the image processing algorithm to automatically decode the payload using training data, as described herein.

In some embodiments, the image data is a set of binary data. Namely, when the image data is analyzed by the image processing algorithm, the image data may be represented as a set of binary data, and the scanning device may apply a binary-to-text encoding algorithm to the image data to decode the encrypted payload. For example, the binary-to-text encoding algorithm may be a Base64 encoding algorithm and/or any other suitable encoding algorithm or combinations thereof.

As previously mentioned, and in some embodiments, the image processing algorithm may be a machine learning-based image processing algorithm. Training the machine learning-based image processing algorithm may include training, by a scan engine (e.g., scan engine 206) included in the scanning device, the machine learning-based image processing algorithm to decode image data featuring a customized image associated with an object using (i) a set of training customized images and (ii) a set of training decrypted payloads. Further, these embodiments may include applying, using the scan engine, the machine learning-based image processing algorithm to the image data to decode and decrypt the encrypted payload associated with the image data.

As an example, a user may establish one or more customized images that may correspond to a particular object. Thus, the set of training customized images may include each of the one or more customized images corresponding to each particular object included as part of the user's AIDC system. The set of training decrypted payloads may include each decrypted payload corresponding to each particular object. Thus, the scan engine may apply the image processing algorithm to each customized image of the set of customized images, and may compare each decoded, decrypted payload to the training decrypted payload corresponding to the training customized image to determine whether or not the image processing algorithm successfully decoded and decrypted the payload from the training customized image. As part of the training, the scan engine may, for example, adjust the weights and/or other parametric characteristics of the image processing algorithm to ensure that each subsequent iteration of applying the image processing algorithm to the set of training customized images results in the image processing algorithm more accurately decoding and decrypting the encoded, encrypted payloads. Accordingly, the machine learning-based image processing algorithm may include any type of machine learning algorithm (e.g., supervised learning, unsupervised learning, reinforcement learning), and may include any suitable specific machine learning algorithm, such as linear regression, logistic regression, decision tree, naïve Bayes, k-nearest neighbors, random forest, support vector machine (SVM), etc.

The method 500 may also include, at block 508, decrypting the encrypted payload. The scanning device may utilize the decryption engine (e.g., decryption engine 208) to apply a decryption algorithm to the encrypted payload. Generally, the payloads may be encrypted prior to encoding within the customized image, and/or the payloads may be encrypted upon decoding from the customized image. For example, a user may utilize a scanning device to capture an image of a customized image, and the scanning device may decode the payload from the customized image. However, prior to transmitting the payload to the server (e.g., server 110) to retrieve the object data corresponding to the object, and/or retrieving the object data stored locally on the scanning device, the scanning device may encrypt the payload and prompt the user to enter a password/passcode. In this example, upon receipt of the password/passcode form the user, the scanning device (e.g., the decryption engine) may decrypt the payload and proceed to retrieve the object data corresponding to the object associated with the customized image. It is to be understood that the server (e.g., server 110) may also decrypt payloads, such that the scanning device may decode and transmit encrypted payloads to the server for decryption prior to retrieving the object data corresponding to the object associated with the customized image. The decryption algorithm may utilize a decryption scheme in accordance with an encryption scheme used initially to encrypt the payloads. Further, the decryption algorithm may include a machine learning-based algorithm configured to automatically decrypt the encrypted payload based on training using a set of training encrypted payloads and a set of training decrypted payloads.

The method 500 may also include, at block 510, transmitting the decrypted payload to a server to obtain data corresponding to the object. Generally, the scanning device may transmit decoded, decrypted payloads to the server, where the server may include a set of data corresponding to one or more objects. When the server receives the decoded, decrypted payload from the scanning device, the server may query or otherwise access the object information (e.g., object information 330) to retrieve object data corresponding to the object associated with the customized image. As previously mentioned, the server may compare identifiers stored with each instance of the object data within the object information 330 to determine what object data should be returned to the scanning device. When the server identifies a match between the decoded, decrypted payload and a respective identifier, the server may transmit an indication of the respective object data back to the scanning device. The indication may include the object data, the identifier, and/or any other suitable information included as part of the object information 330 and/or as included in the transmission from the scanning device to the server or any combinations thereof.

As an example, the user may utilize the scanning device to capture an image of a customized image representing a carton of milk (block 502) that is attached to a carton of milk. The scanning device may decode the encrypted payload encoded within the customized image of the carton of milk using the scan engine (block 506), and may also decrypt the encrypted payload using the decryption engine (block 508). The scanning device may transmit the decoded, decrypted payload to a server containing the object information, where the server compares the decoded, decrypted payload to identifiers included within the object information. When the server identifies a match between a respective identifier and the decoded, decrypted payload, the server may transmit the object data entry (e.g., price of the carton of milk) corresponding to the identifier back to the scanning device. The scanning device may receive the transmission from the server, and may display the price of the carton of milk on a user interface of the scanning device, on a display of a communicatively coupled workstation, and/or on any other suitable display or device.

In some embodiments, the data corresponding to the object (e.g., object data stored in the object information) is an action comprising at least one of (i) following a link to a video corresponding to the object, (ii) retrieving a document associated with the object, and (iii) activating a function of the device. In these embodiments, the scanning device may receive the data corresponding to the object, and may perform the action. Of course, it will be appreciated that the actions corresponding to the object data may include any suitable actions that may be performed by a scanning device, such as a smartphone.

As an example, assume that the object data includes a link to a video showcasing functionality of a table saw that is available for purchase in a hardware store. The scanning device may decode and decrypt the payload associated with the customized image associated with the table saw, and may determine that the scanning device should access the Internet to follow the link. Accordingly, the scanning device may access the Internet, and may download or stream the video to the user interface of the scanning device to display the video to the user. In this example, if the video is stored on the server containing the object information, the scanning device may also retrieve the video from the object information stored on the server.

As another example, assume that the object data includes a document associated with the object, and/or instructions to obtain the document associated with the object. Specifically, assume that the customized image is a desk that is attached to a box containing a desk that requires assembly, and that the document associated with the object is an assembly instruction manual. The scanning device may capture an image of the customized image, and may decode and decrypt the payload. The scanning device may then transmit the payload to the server for analysis and/or may independently analyze the decoded, decrypted payload to determine the document and/or the instructions to obtain the document included as at least a part of the object data. Accordingly, the server may transmit the document and/or the instructions to obtain the document to the scanning device, or the scanning device may independently retrieve the document corresponding to the desk, and as a result, the scanning device may display the assembly instructions necessary to assemble the desk. If the assembly instruction manual is not stored on either the scanning device or the server, the scanning device may access the Internet, and may download the assembly instruction manual to display the assembly instructions on the user interface of the scanning device.

As yet another example, assume that the object data includes instructions causing the scanning device to activate a function of the device. Specifically, assume that the customized image is a representation of a store logo that is placed at a particular location within the associated store, and further assume that the scanning device is a smartphone including an application corresponding to the store. The scanning device may capture an image of the customized image, and may decode and decrypt the payload. The scanning device may then transmit the payload to the server for analysis and/or may independently analyze the decoded, decrypted payload to determine the instructions included as at least a part of the object data. Accordingly, the server may transmit the instructions to the scanning device, or the scanning device may independently execute the instructions to open the application corresponding to the store, and as a result, the scanning device may display a map of the associated store. The displayed map may include, for example, a highlighted or otherwise indicated portion displaying the particular location of the user within the associated store. Further, the scanning device may open the application corresponding to the store, and the application may list items included in the aisle nearest to the user, the application may list discounts currently available on items in the store, and/or any other suitable action associated with the application, as specified in the instructions included in the object data.

The above description refers to a block diagram of the accompanying drawings. Alternative implementations of the example represented by the block diagram includes one or more additional or alternative elements, processes and/or devices. Additionally or alternatively, one or more of the example blocks of the diagram may be combined, divided, re-arranged or omitted. Components represented by the blocks of the diagram are implemented by hardware, software, firmware, and/or any combination of hardware, software and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAs, are specifically configured hardware for performing operations (e.g., one or more of the operations described herein and represented by the flowcharts of this disclosure, if such are present). Some example logic circuits are hardware that executes machine-readable instructions to perform operations (e.g., one or more of the operations described herein and represented by the flowcharts of this disclosure, if such are present). Some example logic circuits include a combination of specifically configured hardware and hardware that executes machine-readable instructions. The above description refers to various operations described herein and flowcharts that may be appended hereto to illustrate the flow of those operations. Any such flowcharts are representative of example methods disclosed herein. In some examples, the methods represented by the flowcharts implement the apparatus represented by the block diagrams. Alternative implementations of example methods disclosed herein may include additional or alternative operations. Further, operations of alternative implementations of the methods disclosed herein may combined, divided, re-arranged or omitted. In some examples, the operations described herein are implemented by machine-readable instructions (e.g., software and/or firmware) stored on a medium (e.g., a tangible machine-readable medium) for execution by one or more logic circuits (e.g., processor(s)). In some examples, the operations described herein are implemented by one or more configurations of one or more specifically designed logic circuits (e.g., ASIC(s)). In some examples the operations described herein are implemented by a combination of specifically designed logic circuit(s) and machine-readable instructions stored on a medium (e.g., a tangible machine-readable medium) for execution by logic circuit(s).

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device” can be read to be implemented by a propagating signal.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. A system for decoding custom, encrypted image data, the system comprising:
a server including a set of data corresponding to one or more objects; and
a device communicatively coupled with the server, wherein the device is configured to:
capture image data featuring a customized image associated with an object of the one or more objects;
decode an encrypted payload associated with the image data, wherein the encrypted payload is encoded in the image data pursuant to a non-standardized format;
decrypt the encrypted payload; and
transmit the decrypted payload to the server to obtain data corresponding to the object.

2. The system of claim 1, wherein the customized image is representative of a human-recognizable object.

3. The system of claim 2, wherein the human-recognizable object substantially correlates to the object, thereby enabling a user to authenticate the data corresponding to the object.

4. The system of claim 1, wherein the non-standardized format corresponds to a non-standardized matching between the encrypted payload and the customized image.

5. The system of claim 1, wherein the device is further configured to:
receive, from a user, a passcode; and
responsive to receiving the passcode, decode the encrypted payload associated with the image data.

6. The system of claim 1, wherein the image data is a set of binary data, and the device is further configured to:
apply a binary-to-text encoding algorithm to the image data to decode the encrypted payload.

7. The system of claim 6, wherein the binary-to-text encoding algorithm is a Base64 encoding algorithm.

8. The system of claim 1, wherein the data corresponding to the object is an action comprising at least one of (i) following a link to a video corresponding to the object, (ii) retrieving a document associated with the object, and (iii) activating a function of the device, and wherein the device is further configured to:
receive, from the server, the data corresponding to the object; and
perform the action.

9. The system of claim 1, wherein the device is further configured to:
train, by a scan engine, a machine learning-based image processing algorithm to decode image data featuring a customized image associated with an object using (i) a set of training customized images and (ii) a set of training decrypted payloads; and
apply the machine learning-based image processing algorithm to the image data to decode the encrypted payload associated with the image data.

10. A method for decoding custom, encrypted image data, the method comprising:
capturing, by a device, image data featuring a customized image associated with an object;
decoding, by the device, an encrypted payload associated with the image data, wherein the encrypted payload is encoded in the image data pursuant to a non-standardized format;
decrypting, by the device, the encrypted payload; and
transmitting, by the device, the decrypted payload to a server to obtain data corresponding to the object, wherein the server includes a set of data corresponding to one or more objects.

11. The method of claim 10, wherein the customized image is representative of a human-recognizable object.

12. The method of claim 11, wherein the human-recognizable object substantially correlates to the object, thereby enabling a user to authenticate the data corresponding to the object.

13. The method of claim 10, wherein the non-standardized format corresponds to a non-standardized matching between the encrypted payload and the customized image.

14. The method of claim 10, further comprising:
receiving, from a user interacting with the device, a passcode; and
responsive to receiving the passcode, decoding, by the device, the encrypted payload associated with the image data.

15. The method of claim 10, wherein the image data is a set of binary data, and the method further comprises:
applying, by the device, a binary-to-text encoding algorithm to the image data to decode the encrypted payload.

16. The method of claim 15, wherein the binary-to-text encoding algorithm is a Base64 encoding algorithm.

17. The method of claim 10, wherein the data corresponding to the object is an action comprising at least one of (i) following a link to a video corresponding to the object, (ii) retrieving a document associated with the object, and (iii) activating a function of the device, and wherein the method further comprises:
receiving, at the device, the data corresponding to the object; and
performing, by the device, the action.

18. The method of claim 10, wherein the method further comprises:
training, by a scan engine included in the device, a machine learning-based image processing algorithm to decode image data featuring a customized image associated with an object using (i) a set of training customized images and (ii) a set of training decrypted payloads; and
applying, by the scan engine, the machine learning-based image processing algorithm to the image data to decode the encrypted payload associated with the image data.

19. A tangible machine-readable medium comprising instructions that, when executed, cause a machine to at least:
capture image data featuring a customized image associated with an object;
decode an encrypted payload associated with the image data, wherein the encrypted payload is encoded in the image data pursuant to a non-standardized format;
decrypt the encrypted payload; and
transmit the decrypted payload to a server to obtain data corresponding to the object, wherein the server includes a set of data corresponding to one or more objects.

20. The tangible machine-readable medium of claim 19, wherein the customized image is representative of a human-recognizable object that substantially correlates to the object, thereby enabling a user to authenticate the data corresponding to the object, and wherein the non-standardized format corresponds to a non-standardized matching between the encrypted payload and the customized image.
